(19) United States
(12) Patent Application Publication
(10) Pub. No.: US 2026/0312082 A1
(43) Pub. Date: Oct. 8, 2026

(54) MESH, WATER ELECTROLYSIS APPARATUS, AND FUEL CELL

(71) Applicants: Sumitomo Electric Toyama Co., Ltd., Imizu-shi, Toyama (JP); Sumitomo Electric Industries, Ltd., Osaka-shi, Osaka (JP)

(72) Inventors: Masatoshi MAJIMA, Imizu-shi (JP); Hitoshi TSUCHIDA, Imizu-shi (JP); Kazuki OKUNO, Osaka-shi (JP); Koma NUMATA, Osaka-shi (JP); Kazunari MIYAMOTO, Imizu-shi (JP)

(73) Assignees: Sumitomo Electric Toyama Co., Ltd., Imizu-shi, Toyama (JP); Sumitomo Electric Industries, Ltd., Osaka-shi, Osaka (JP)

(21) Appl. No.: 18/996,703

(22) PCT Filed: Jun. 27, 2024
(86) PCT No.: PCT/JP2024/023341

§ 371 Date: Jan. 17, 2025

(30) Foreign Application Priority Data
Aug. 30, 2023 (JP) 2023-139548

(51) Int. Cl. H01M 8/0232; C25B 11/03; C25B 11/042; C25B 11/046

(52) U.S. Cl. CPC H01M 8/0232; C25B 11/03; C25B 11/042; C25B 11/046

(57) ABSTRACT

A mesh is constituted of a framework including a plurality of supporting pillar portions and a plurality of node portions. Each of the plurality of node portions connects two or more supporting pillar portions of the plurality of supporting pillar portions. The framework consists of a framework main body and an inner portion surrounded by the framework main body. The framework main body consists essentially of nickel or a nickel alloy.

### TECHNICAL FIELD

The present disclosure relates to a mesh, a water electrolysis apparatus, and a fuel cell. The present application claims priority based on Japanese Patent Application No. 2023-139548 filed on Aug. 30, 2023. The entire contents of the Japanese Patent Application are incorporated herein by reference.

### BACKGROUND ART

Conventionally, a mesh composed of a metal has been used in an electronic device, a water electrolysis electrode, or the like (PTL 1).

### CITATION LIST

### Patent Literature

PTL 1: Japanese Patent Laying-Open No. 2009-185378

### SUMMARY OF INVENTION

A mesh according to one embodiment of the present disclosure is constituted of a framework including a plurality of supporting pillar portions and a plurality of node portions. Each of the plurality of node portions connects two or more supporting pillar portions of the plurality of supporting pillar portions. The framework consists of a framework main body and an inner portion surrounded by the framework main body. The framework main body consists essentially of nickel or a nickel alloy.

### BRIEF DESCRIPTION OF DRAWINGS

FIG. 1 is a plan view of a mesh according to a first embodiment.

FIG. 2 is an end view of a supporting pillar portion of the mesh according to the first embodiment as viewed in a direction of line with arrows II-II in FIG. 1.

FIG. 3 is an end view of a node portion of the mesh according to the first embodiment as viewed in a direction of line with arrows III-III in FIG. 1.

FIG. 4 is a diagram showing a flowchart of a method of manufacturing the mesh according to the first embodiment.

FIG. 5 is a plan view of a mesh according to a second embodiment.

FIG. 6 is an end view of the mesh according to the second embodiment as viewed in a direction of line with arrows VI-VI in FIG. 5.

FIG. 7 is a diagram showing a flowchart of a method of manufacturing the mesh according to the second embodiment.

FIG. 8 is a plan view of a mesh according to a first modification of the second embodiment.

FIG. 9 is a plan view of a mesh according to a second modification of the second embodiment.

FIG. 10 is a plan view of a mesh according to a third modification of the second embodiment.

FIG. 11 is a plan view of a mesh according to a fourth modification of the second embodiment.

FIG. 12 is a plan view of a mesh according to a fifth modification of the second embodiment.

FIG. 13 is a schematic partial cross sectional view of a water electrolysis apparatus according to a third embodiment.

FIG. 14 is a schematic partial cross sectional view of a fuel cell according to a fourth embodiment.

FIG. 15 is a schematic partial cross sectional view of a cell of the fuel cell according to the fourth embodiment.

### DETAILED DESCRIPTION

[Problem to be Solved by the Present Disclosure]

In recent years, a mesh composed of a metal has been used as a water electrolysis electrode. Such a mesh composed of a metal is required to have excellent mechanical strength and low electrical resistance. However, in a mesh formed by knitting drawn metal filaments, a warp thread (metal filament) and a weft thread (metal filament) are merely in contact with each other at a location at which they intersect each other. Therefore, it is difficult to achieve excellent mechanical strength and low electrical resistance in such a mesh.

The present disclosure has been made in view of the above-described problem and has an object to provide a mesh having more excellent mechanical strength and lower electrical resistance. [Advantageous Effect of the Present Disclosure]

According to the present disclosure, a mesh having more excellent mechanical strength and lower electrical resistance can be provided.

### DESCRIPTION OF EMBODIMENTS

First, embodiments of the present disclosure will be listed and described.

[1] A mesh according to one embodiment of the present disclosure is constituted of a framework including a plurality of supporting pillar portions and a plurality of node portions. Each of the plurality of node portions connects two or more supporting pillar portions of the plurality of supporting pillar portions. The framework consists of a framework main body and an inner portion surrounded by the framework main body. The framework main body consists essentially of nickel or a nickel alloy.

In the mesh of the present disclosure, the two or more supporting pillar portions are integrated at the node portion. Thus, the mesh has more excellent mechanical strength and lower electrical resistance.

[2] In [1], in a cross section of a center of each of the plurality of node portions along a long-side direction of one supporting pillar portion of the two or more supporting pillar portions, a first ratio of a minor axis of the inner portion to a major axis of the inner portion may be 0.01 or more and 0.9 or less. In a cross section of a center of the one supporting pillar portion perpendicular to the long-side direction, a second ratio of a second length of the inner portion to a first length of the inner portion may be 0.1 or more and 1.0 or less. The first length is a length of the inner portion in an in-plane direction of the mesh in the cross section of the center of the one supporting pillar portion. The second length is a length of the inner portion in a thickness direction of the mesh in the cross section of the center of the one supporting pillar portion.

Therefore, unevenness in the surface of the mesh is decreased. A member provided adjacent to the mesh is prevented from being struck and broken by the mesh. When the member is an insulating member such as a membrane of a zero-gap type water electrolysis cell, an insulating property of the insulating member can be secured.

[3] In [1] or [2], a content ratio of a first atom in the framework main body may be 0 ppm or more and 100 ppm or less on a mass basis, and the first atom may be at least one atom selected from a group consisting of a phosphorus atom and a boron atom.

The melting point of the nickel or the melting point of the nickel alloy is decreased by a reductant component inevitably mixed at the time of reduction of the first atom. Thus, the mesh has more excellent mechanical strength and lower electrical resistance. [4] In any one of [1] to [3], the inner portion may be hollow.

Therefore, the mesh having more excellent mechanical strength, lower electrical resistance, and lighter weight can be provided. Further, the thickness of the mesh can be readily adjusted by performing rolling onto the mesh. The mesh is facilitated to be brought into close contact with a member (for example, a membrane of a water electrolysis cell or the like) adjacent to the mesh.

[5] In any one of [1] to [3], the inner portion may consist of a resin having alkali resistance or a carbon fiber having alkali resistance.

Therefore, the mesh has more excellent alkali resistance. Since the inner portion of the framework is solid, the mesh has more excellent mechanical strength. The mesh can be suitably used for a water electrolysis electrode of a water electrolysis apparatus using a strong alkaline solution.

[6] In [5], the resin having alkali resistance may be at least one resin selected from a group consisting of polypropylene, polyethylene, polyester, nylon, and polytetrafluoroethylene.

Therefore, the mesh has more excellent alkali resistance. Since the inner portion of the framework is solid, the mesh has more excellent mechanical strength. The mesh can be suitably used for a water electrolysis electrode of a water electrolysis apparatus using a strong alkaline solution.

[7] In any one of [1] to [6], an opening ratio of the mesh may be 0.2% or more and 80% or less.

Since the opening ratio of the mesh is 0.2% or more, the mesh can permit liquid and gas to pass therethrough. The mesh can be suitably used for a water electrolysis electrode of a water electrolysis apparatus using a strong alkaline solution. Further, since the opening ratio of the mesh is 80% or less, the mesh has more excellent mechanical strength.

[8] In any one of [1] to [7], an average equivalent circle diameter of the plurality of supporting pillar portions in cross sections of the plurality of supporting pillar portions perpendicular to long-side directions of the plurality of supporting pillar portions may be 0.007 mm or more and 0.5 mm or less.

Therefore, the mesh has more excellent mechanical strength.

[9] In any one of [1] to [8], the mesh has a main surface in which a groove is formed. A depth of the groove may be 10% or more of a thickness of the mesh. In a plan view of the main surface, an area of the groove may be 10% or more of an area of the main surface.

Therefore, uniformity of flow of fluid such as gas and liquid in the mesh can be improved.

In [9], in the plan view, the mesh has a first edge, a second edge opposite to the first edge, a third edge, and a fourth edge opposite to the third edge. Each of the third edge and the fourth edge is connected to the first edge and the second edge. In the plan view, the framework may have a shape of a lattice. Each of a plurality of line-shaped bodies of the lattice may extend from one of the first edge, the second edge, the third edge, and the fourth edge to another one of the first edge, the second edge, the third edge, and the fourth edge. A minimum value of a ratio of a length of a portion, in which the groove is not formed, of each of the plurality of line-shaped bodies may be 10% or more.

Therefore, uniformity of flow of fluid such as gas and liquid in the mesh can be improved.

A water electrolysis apparatus according to one embodiment of the present disclosure includes: a current collector; a membrane; and an electrode disposed between the current collector and the membrane. At least one of the electrode or the current collector is composed of the mesh according to any one of [1] to [10].

Therefore, uniformity of flow of an aqueous solution in at least one of the electrode and the current collector can be improved. Moreover, gas generated in the water electrolysis apparatus is promoted to be discharged. Performance of the water electrolysis apparatus can be improved.

A fuel cell according to one embodiment of the present disclosure includes a current collector, an electrolyte, and an electrode disposed between the current collector and the electrolyte. The current collector is composed of the mesh according to any one of [1] to [10].

Therefore, uniformity of flow of gas in the current collector can be improved.

Performance of the fuel cell can be improved.

### Details of Embodiments of the Present Disclosure

Embodiments of the present disclosure will be described below with reference to figures. In each of the figures of the present disclosure, the same reference characters represent the same or corresponding portions. Moreover, dimensional relations such as length, width, thickness, and depth are appropriately changed for clarity and simplification of the figures, and do not necessarily represent actual dimensional relations.

### First Embodiment

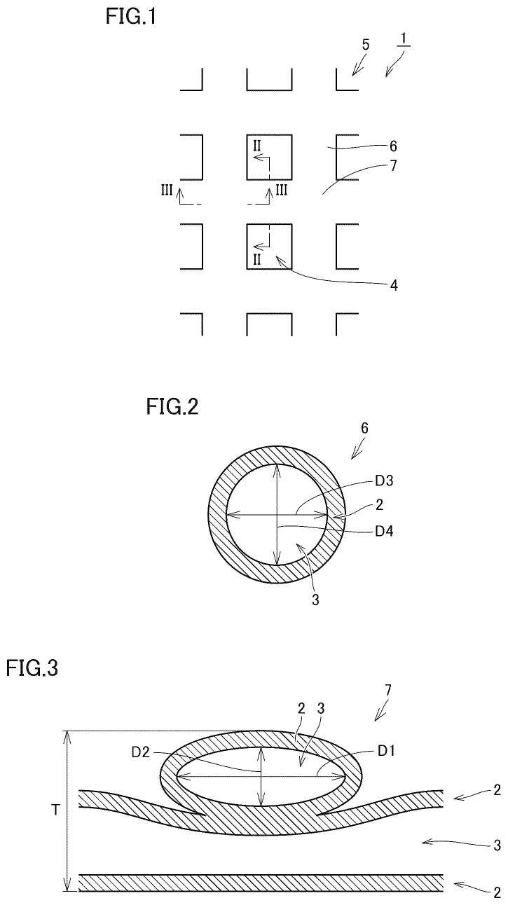

A mesh 1 according to a first embodiment will be described with reference to FIGS. 1 to 3. FIG. 1 is a plan view of mesh 1. FIG. 2 is an end view as viewed in a direction of line with arrows II-II in FIG. 1. FIG. 3 is an end view as viewed in a direction of line with arrows III-III in FIG. 1.

Mesh 1 is constituted of a framework 5 including a plurality of supporting pillar portions 6 and a plurality of node portions 7. Each of the plurality of node portions 7 connects two or more supporting pillar portions 6 of the plurality of supporting pillar portions 6. Framework 5 consists of a framework main body 2 and an inner portion 3 surrounded by framework main body 2. Framework main body 2 consists essentially of nickel or a nickel alloy.

Therefore, mesh 1 has excellent mechanical strength and low electrical resistance. This is presumably due to the following reason: framework 5 of mesh 1 has a structure in which a plurality of hollow metal filaments are connected together by metallic bond at each of the plurality of node portions 7, rather than a structure in which metal filaments are in contact with each other at a location at which they intersect each other.

### <<Mesh 1>>

### <Structure of Mesh 1>

Mesh 1 according to the present embodiment is constituted of framework 5 including the plurality of supporting pillar portions 6 and the plurality of node portions 7. Each of the plurality of node portions 7 connects two or more supporting pillar portions 6 of the plurality of supporting pillar portions 6. Each of the plurality of node portions 7 may connect three or more supporting pillar portions 6 of the plurality of supporting pillar portions 6. Each of the plurality of node portions 7 may connect seven or less supporting pillar portions 6 of the plurality of supporting pillar portions 6, may connect six or less supporting pillar portions 6 of the plurality of supporting pillar portions 6, may connect five or less supporting pillar portions 6 of the plurality of supporting pillar portions 6, or may connect four or less supporting pillar portions 6 of the plurality of supporting pillar portions 6. Each of the plurality of node portions 7 may connect two or more and seven or less supporting pillar portions 6 of the plurality of supporting pillar portions 6, may connect three or more and six or less supporting pillar portions 6 of the plurality of supporting pillar portions 6, may connect three or more and five or less supporting pillar portions 6 of the plurality of supporting pillar portions 6, or may connect three or more and four or less supporting pillar portions 6 of the plurality of supporting pillar portions 6. Each of the plurality of node portions 7 may connect three supporting pillar portions 6, may connect four supporting pillar portions 6, may connect five supporting pillar portions 6, may connect six supporting pillar portions 6, or may connect seven supporting pillar portions 6. It should be noted that in the present disclosure, mesh 1 refers to a structure in the form of a mesh. The structure in the form of a mesh is also referred to as a mesh structure.

The average equivalent circle diameter of the plurality of supporting pillar portions 6 in the cross sections of the plurality of supporting pillar portions 6 perpendicular to the long-side directions of the plurality of supporting pillar portions 6 may be 0.007 mm or more and 0.5 mm or less. Thus, mesh 1 has more excellent mechanical strength. The lower limit of the average equivalent circle diameter of the plurality of supporting pillar portions 6 may be 0.007 mm or more, 0.01 mm or more, or 0.1 mm or more. The upper limit of the average equivalent circle diameter of the plurality of supporting pillar portions 6 may be 0.5 mm or less, 0.3 mm or less, or 0.2 mm or less. The average equivalent circle diameter of the plurality of supporting pillar portions 6 may be 0.01 mm or more and 0.3 mm or less, or may be 0.1 mm or more and 0.2 mm or less.

The average equivalent circle diameter of supporting pillar portions 6 in the cross sections perpendicular to the long-side directions of supporting pillar portions 6 can be specified by the following method. A cross section polisher (CP) is used to obtain the cross sections of supporting pillar portions 6 perpendicular to the long-side directions of supporting pillar portions 6. Then, the cross sections of supporting pillar portions 6 are observed with a scanning electron microscope (SEM). Finally, the average value of the equivalent circle diameters of any ten supporting pillar portions 6 in the cross sections of supporting pillar portions 6 is calculated. In this way, the average equivalent circle diameter of supporting pillar portions 6 can be specified.

The opening ratio of mesh 1 may be 0.2% or more and 80% or less. Since the opening ratio of mesh 1 is 0.2% or more, fluid is facilitated to pass through mesh 1 and mesh 1 has a lighter weight. Since the opening ratio of mesh 1 is 80% or less, mesh 1 has more excellent mechanical strength and lower electrical resistance. The lower limit of the opening ratio of mesh 1 may be 0.2% or more, 6% or more, 10% or more, 20% or more, 25% or more, or 40% or more. The upper limit of the opening ratio of mesh 1 may be 80% or less, 70% or less, or 60% or less. The opening ratio of mesh 1 may be 0.2% or more and 70% or less, 60% or more and 80% or less, 6% or more and 70% or less, 10% or more and 70% or less, 20% or more and 70% or less, or 40% or more and 60% or less.

The opening ratio of mesh 1 can be measured by using an opening ratio measurement apparatus disclosed in Japanese Patent Laying-Open No. 2005-290623.

Referring to FIG. 3, thickness T of mesh 1 is the maximum thickness of node portion 7. Thickness T of mesh 1 may be 0.05 mm or more and 0.5 mm or less. Thus, the mechanical strength of mesh 1 can be further increased. The lower limit of thickness T of mesh 1 may be 0.05 mm or more, 0.1 mm or more, or 0.2 mm or more. The upper limit of thickness T of mesh 1 may be 0.5 mm or less, 0.4 mm or less, or 0.3 mm or less. Thickness T of mesh 1 may be 0.1 mm or more and 0.4 mm or less, or may be 0.2 mm or more and 0.3 mm or less.

Thickness T of mesh 1 can be specified by the following method. First, a digital thickness gauge (Teclock) is used to measure the thicknesses of node portions 7 at any ten locations in mesh 1. Then, the average value of the thicknesses of node portions 7 at the ten locations is calculated. Thus, thickness T of mesh 1 is specified.

The shape of each opening 4 of mesh 1 is not particularly limited, but can be, for example, a quadrangular shape, a hexagonal shape, an elliptical shape, or a triangular shape. The quadrangular shape may be, for example, a square shape, a rectangular shape, or a diamond shape.

A quantity of framework 5 per unit area may be 10 g/m² or more and 1000 g/m² or less. Therefore, disconnection is less likely to occur (in other words, framework 5 is less likely to be cut) and mesh 1 is readily bent, with the result that mesh 1 can be readily manufactured by successive facilities for plating and heat treatment and mesh 1 can have a lighter weight. It should be noted that the lower limit of the quantity per unit area may be 50 g/m² or more, 100 g/m² or more, or 200 g/m² or more. The upper limit of the quantity per unit area may be 800 g/m² or less, 500 g/m² or less, or 400 g/m² or less. The quantity per unit area can be determined by the Archimedes' method.

Framework 5 consists of framework main body 2 and inner portion 3 surrounded by framework main body 2. Thus, particularly when used as a water electrolysis electrode, mesh 1 can have improved mechanical strength, low electrical resistance, and lighter weight. It should be noted that the expression “framework 5 consists of framework main body 2 and inner portion 3 surrounded by framework main body 2” is also understandable as “the composition of framework main body 2 is different from the composition of inner portion 3 surrounded by framework main body 2 in framework 5”. Further, the expression “framework 5 consists of framework main body 2 and inner portion 3 surrounded by framework main body 2” is a concept encompassing, for example, a case where framework 5 has an end surface and inner portion 3 is exposed to outside of mesh 1 at the end surface of framework 5.

The fact “framework 5 consists of framework main body 2 and inner portion 3 surrounded by framework main body 2” can be specified by the following method. By observing a cross section of a supporting pillar portion 6 perpendicular to the long-side direction of supporting pillar portion 6 at any one location of framework 5, it is confirmed that “framework 5 consists of framework main body 2 and inner portion 3 surrounded by framework main body 2” in the cross section. Next, the fact “framework 5 consists of framework main body 2 and inner portion 3 surrounded by framework main body 2” is confirmed in the same manner at any other four locations of framework 5. In this way, the fact “framework 5 consists of framework main body 2 and inner portion 3 surrounded by framework main body 2” is specified in mesh 1.

### <Framework Main Body>

Framework main body 2 consists essentially of nickel or a nickel alloy. Therefore, the mechanical strength of mesh 1 is improved and the electrical resistance of mesh 1 can be suppressed to be low. Here, the expression “framework main body 2 consists essentially of nickel or a nickel alloy” means that framework main body 2 can contain a component other than nickel as long as the effects of the present disclosure are not impaired. Examples of the other component include a below-described first atom, cobalt, chromium, tin, copper, and iron. Further, in the present embodiment, nickel means a nickel atom. The nickel alloy may be at least one alloy selected from a group consisting of a NiCo alloy, a NiCr alloy, a NiSn alloy, a NiCu alloy, and a NiFe alloy.

The first atom is inevitably contained in a plating solution used in a plating step (S3) described later. The first atom is incorporated into framework main body 2 in the plating step (S3). The first atom is, for example, at least one atom selected from a group consisting of a phosphorus atom and a boron atom.

The content ratio of the first atom in framework main body 2 may be 0 ppm or more and 100 ppm or less on a mass basis. Since nickel and the first atom form a eutectic, the melting point of framework main body 2 becomes lower than the melting point of nickel. Therefore, in a heat treatment step (S4) described later, mesh 1 becomes more flexible to repair a plating defect of framework main body 2. Mesh 1 has more excellent mechanical strength and lower electrical resistance. The lower limit of the content ratio of the first atom in framework main body 2 may be 0 ppm or more, 5 ppm or more, or 10 ppm or more on a mass basis. The upper limit of the content ratio of the first atom in framework main body 2 may be 100 ppm or less, 50 ppm or less, or 30 ppm or less on a mass basis. The content ratio of the first atom in framework main body 2 may be 5 ppm or more and 50 ppm or less, or may be 10 ppm or more and 30 ppm or less.

The composition of framework main body 2 can be measured by dissolving all the metal components of framework main body 2 and then performing ICP emission spectroscopy/mass spectrometry.

### <Inner Portion>

Inner portion 3 may be hollow. Therefore, a quantity of metal of framework main body 2 is suppressed to be relatively low and the surface area of framework 5 becomes large. Mesh 1 having more excellent mechanical strength, lower electrical resistance, and lighter weight can be provided. Further, particularly when the shape of opening 4 is a quadrangular shape, the mechanical strength of mesh 1 in a direction along a diagonal of the quadrangular shape is improved because inner portion 3 is hollow.

It can be specified by the following method that inner portion 3 is hollow. A CP is used to obtain a cross section of framework 5. Then, the cross section of framework 5 is observed with a SEM. In this way, it can be specified that inner portion 3 is hollow.

Inner portion 3 may consist of a resin having alkali resistance or a carbon fiber having alkali resistance. Therefore, mesh 1 has more excellent alkali resistance. Since inner portion 3 of framework 5 is solid, mesh 1 has more excellent mechanical strength. Mesh 1 can be suitably used for a water electrolysis electrode of a water electrolysis apparatus using a strong alkaline solution.

The resin having alkali resistance may be at least one resin selected from a group consisting of polypropylene, polyethylene, polyester, nylon, and polytetrafluoroethylene. Inner portion 3 may be composed of a material having more flexibility than that of framework main body 2.

Inner portion 3 may be composed of a material having a smaller specific gravity than that of framework main body 2. Therefore, the metal (i.e., nickel or nickel alloy) and the resin having higher flexibility than that of the metal (nickel or nickel alloy) form a composite material. Framework 5 is composed of the composite material. Therefore, mesh 1 having more excellent mechanical strength, lower electrical resistance, and lighter weight can be provided.

The carbon fiber having alkali resistance may be at least one carbon fiber selected from a group consisting of a polyacrylonitrile (PAN) calcinated carbon fiber and a pitch-based carbon fiber. Thus, the metal (i.e., nickel or nickel alloy) and the carbon fiber having higher flexibility than that of the metal (nickel or nickel alloy) form a composite material. Framework 5 is composed of the composite material. Therefore, mesh 1 having more excellent mechanical strength, lower electrical resistance, and lighter weight can be provided.

It can be specified by the following method that inner portion 3 consists of the resin having alkali resistance or the carbon fiber having alkali resistance. First, the mass (hereinafter, also referred to as “first mass”) of mesh 1 is measured. Next, mesh 1 is immersed in about 6 mol/L of a KOH solution at 70° C. for one week. Next, mesh 1 after the immersion is cleaned with water and is then dried. Next, the mass (hereinafter, also referred to as “second mass”) of mesh 1 having been dried is measured. Next, “[{(first mass)−(second mass)}/(first mass)]×100” is calculated. When “[{(first mass)−(second mass)}/(first mass)]×100” is 5% or less, it is specified that “inner portion 3 consists of the resin having alkali resistance or the carbon fiber having alkali resistance”.

The filament diameter of the carbon fiber having alkali resistance may be 0.05 mm or more and 0.5 mm or less. Therefore, mesh 1 having more excellent mechanical strength, lower electrical resistance, and lighter weight can be provided. The lower limit of the filament diameter of the carbon fiber having alkali resistance may be 0.05 mm or more, or may be 0.07 mm or more. The upper limit of the filament diameter of the carbon fiber having alkali resistance may be 0.5 mm or less, 0.2 mm or less, or 0.1 mm or less. The filament diameter of the carbon fiber having alkali resistance may be 0.05 mm or more and 0.2 mm or less, or may be 0.07 mm or more and 0.1 mm or less.

The filament diameter of the carbon fiber having alkali resistance can be specified in accordance with a test method of “Carbon fibre-Determination of filament diameter and cross-sectional area” in “JISR7607:2000”.

The density of the carbon fiber having alkali resistance may be 1.7 g/cm³ or more and 1.9 g/cm³ or less. Therefore, mesh 1 having more excellent mechanical strength, lower electrical resistance, and lighter weight can be provided. The lower limit of the density of the carbon fiber having alkali resistance may be 1.79 g/cm³ or more, 1.80 g/cm³ or more, or 1.81 g/cm³ or more. The upper limit of the density of the carbon fiber having alkali resistance may be 1.9 g/cm³ or less, 1.85 g/cm³ or less, or 1.83 g/cm³ or less. The density of the carbon fiber having alkali resistance may be 1.79 g/cm³ or more and 1.85 g/cm³ or less, or may be 1.81 g/cm³ or more and 1.83 g/cm³ or less.

The density of the carbon fiber having alkali resistance can be specified in accordance with a test method of “Carbon fiber-Determination of density” in “JISR7603:1999”.

### <First Ratio and Second Ratio>

Referring to FIG. 3, a first ratio D2/D1 of a minor axis D2 of inner portion 3 to a major axis D1 of inner portion 3 may be 0.01 or more and 0.9 or less in a cross section of a center of node portion 7 along a long-side direction of one supporting pillar portion 6 of two or more supporting pillar portions 6 connected by each of the plurality of node portions 7. Major axis D1 of inner portion 3 is the length of inner portion 3 in the in-plane direction of mesh 1 in the cross section of the center of node portion 7 along the long-side direction of one supporting pillar portion 6. Minor axis D2 of inner portion 3 is the length of inner portion 3 in the thickness direction of mesh 1 in the cross section of the center of node portion 7 along the long-side direction of one supporting pillar portion 6.

Referring to FIG. 2, a second ratio D4/D3 of a second length D4 of inner portion 3 to a first length D3 of inner portion 3 may be 0.1 or more and 1.0 or less in a cross section of the center of one supporting pillar portion 6 perpendicular to the long-side direction of one supporting pillar portion 6 of two or more supporting pillar portions 6 connected by each of the plurality of node portions 7. First length D3 of inner portion 3 is a length of inner portion 3 in the in-plane direction of mesh 1 in the cross section of the center of one supporting pillar portion 6. Second length D4 of inner portion 3 is a length of inner portion 3 in the thickness direction of mesh 1 in the cross section of the center of one supporting pillar portion 6.

Therefore, unevenness in the surface of mesh 1 is decreased. A member provided adjacent to mesh 1 is prevented from being broken by mesh 1. When the member is an insulating member such as a membrane of a zero-gap type water electrolysis cell, an insulating property of the insulating member can be secured. Moreover, when inner portion 3 is hollow, node portion 7 is less likely to be damaged while maintaining a large surface area of mesh 1. Therefore, mesh 1 having more excellent mechanical strength, lower electrical resistance, and lighter weight can be provided.

The lower limit of first ratio D2/D1 may be 0.01 or more, 0.05 or more, or 0.1 or more. The upper limit of first ratio D2/D1 may be 0.9 or less, 0.5 or less, or 0.4 or less. First ratio D2/D1 may be 0.05 or more and 0.5 or less, or may be 0.1 or more and 0.4 or less.

First ratio D2/D1 can be specified by the following method. A CP is used to obtain the cross section of the center of node portion 7 along the long-side direction of one supporting pillar portion 6 of two or more supporting pillar portions 6 connected by each of the plurality of node portions 7. Then, the cross section of the center of node portion 7 is observed with a SEM. The average value of first ratios D2/D1 at any ten locations in the cross section of the center of node portion 7 is calculated. In this way, first ratio D2/D1 can be specified.

The lower limit of second ratio D4/D3 may be 0.1 or more, 0.2 or more, or 0.4 or more. The upper limit of second ratio D4/D3 may be 1.0 or less, 0.8 or less, or 0.5 or less. Second ratio D4/D3 may be 0.2 or more and 0.8 or less, or may be 0.4 or more and 0.5 or less.

Second ratio D4/D3 can be specified by the following method. A CP is used to obtain the cross section of the center of one supporting pillar portion 6 of two or more supporting pillar portions 6 connected by each of the plurality of node portions 7, the cross section being perpendicular to the long-side direction of one supporting pillar portion 6. Then, the cross section of the center of supporting pillar portion 6 is observed with a SEM. The average value of second ratios D4/D3 at any ten locations in the cross section of the center of supporting pillar portion 6 is calculated. In this way, second ratio D4/D3 can be specified.

### Application

Mesh 1 according to the present embodiment can be used as a water electrolysis electrode. Moreover, mesh 1 according to the present embodiment can also be suitably used in, for example, a solid oxide fuel cell, a solid oxide steam electrolysis cell, a water electrolysis cell, an electromagnetic wave shield, or the like. It should be noted that examples of the water electrolysis cell include an alkaline water electrolysis cell and an anion exchange membrane water electrolysis cell.

### [Method of Manufacturing Mesh 1]

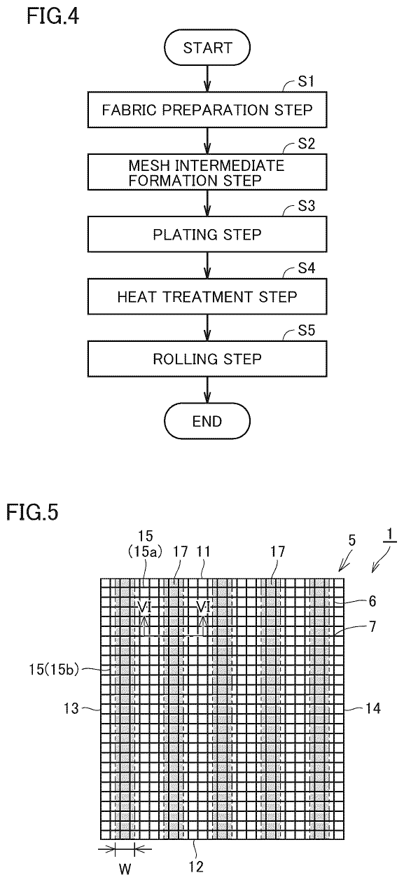

A method of manufacturing mesh 1 according to the present embodiment will be described with reference to FIG. 4.

For example, the method of manufacturing mesh 1 according to the present embodiment includes the following steps in the following order: a step (step S1) of preparing a fabric; a step (step S2) of obtaining a mesh intermediate; and a step (step S3) of plating a surface of the mesh intermediate. The method of manufacturing mesh 1 according to the present embodiment may further include a heat treatment step (step S4) after the plating step (step S3). The method of manufacturing mesh 1 according to the present embodiment may further include a rolling step (step S5).

### Step S1

In step S1, a fabric is prepared. The fabric may be prepared by purchasing a commercially available product, or may be prepared by manufacturing it using a conventionally known method.

A weave of the fabric may be one weave selected from a group consisting of plain weave, twill weave, satin weave, plain Dutch weave, herringbone weave, twilled Dutch weave, honeycomb weave, 3D fabric weave, and the like. The filament diameter of the fabric is not particularly limited, but may be, for example, 0.007 mm or more and 2 mm or less. The opening of the fabric is not particularly limited, but may be, for example, 0.004 mm or more and 1 mm or less. The pitch of the fabric is not particularly limited, but may be, for example, 0.007 mm or more and 3 mm or less.

The fabric may consist of the above-described resin having alkali resistance or the above-described carbon fiber having alkali resistance. The carbon fiber has conductivity. Therefore, when the fabric consists of the carbon fiber having alkali resistance, step S2 described below can be omitted.

### Step S2

In step S2, a conductive coating layer is formed on a surface of the fabric. For example, a conductive paste is applied to the surface of the fabric. Then, a solvent is volatilized from the conductive paste. In this way, a mesh intermediate is obtained. In conductive paste, 3 parts by mass or more and 50 parts by mass or less of conductive carbon particles may be contained with respect to 100 parts by mass of the solvent. Examples of the solvent include water and the like. Examples of the conductive carbon particles include natural graphite, artificial graphite, and the like. In the present disclosure, the term “conductivity” means “electrical conductivity”.

### Step S3

In step S3, plating such as nickel plating is performed onto a surface of the mesh intermediate. The plating can be performed by a conventionally known method. It should be noted that in the nickel plating, the plating of Ni may be performed at the same time as plating of Co, Cr, Sn, Cu, Fe, or the like, or the plating of Co, Cr, Sn, Cu, Fe, or the like may be performed after the nickel plating is performed. Mesh 1 having framework 5 with its inner portion being the fabric is obtained by steps S1 to S3. In order to obtain mesh 1 having framework 5 with its inner portion being hollow, step S4 is performed.

### Step S4

In step S4, the mesh intermediate having been plated is subjected to heat treatment. With this heat treatment, the fabric is removed, with the result that the inner portion of framework 5 becomes hollow. Conditions of the heat treatment are not particularly limited; however, the heat treatment temperature may be 800° C. or more and 1200° C. or less, and the heat treatment time may be 5 minutes or more and 60 minutes or less, for example. In this way, mesh 1 having framework 5 with its inner portion being hollow is obtained.

### Step S5

Step S5 is a rolling step performed to adjust the thickness of mesh 1. Rolling is performed onto mesh 1 having framework 5 with its inner portion being hollow as obtained in step S3 or mesh 1 having framework 5 with its inner portion being hollow as obtained in step S4. As shown in FIG. 3, the length of the inner portion in the thickness direction of mesh 1 is decreased, thereby decreasing the thickness of mesh 1. The length of the inner portion in the thickness direction of mesh 1 is smaller than the length of the inner portion in the in-plane direction of mesh 1. In this way, the thickness of mesh 1 is adjusted.

### EXAMPLES

The present embodiment will be described more specifically with reference to examples. It should be noted that the present embodiment is not limited by these examples.

### <<Preparation of Meshes According to Samples 1 to 21>>

Each of meshes according to samples 1 to 21 was manufactured by the following method.

### <Fabric Preparation Step>

A fabric consisting of a resin described in Table 1 and having weave, filament diameter, opening, and pitch as described in Table 1 was prepared by purchasing a commercially available product.

### <Mesh Intermediate Formation Step>

A conductive paste was prepared by using artificial graphite (conductive carbon particles) and an acrylic-based adhesive agent as a raw material containing carbon atoms and by dispersing the artificial graphite (conductive carbon particles) at parts by mass described in Table 1 with respect to 100 parts by mass of water (solvent). Next, the conductive paste was applied onto a surface of the fabric. Next, the conductive paste was dried in vacuum at 80° C. for 0.1 hour to volatilize the water (solvent) from the conductive paste. In this way, a mesh intermediate was obtained.

### <Plating Step>

The mesh intermediate was subjected to nickel plating using the following composition of the plating bath and the following electrolysis conditions, thereby obtaining the mesh.

### (Composition of Plating Bath)

Salt (aqueous solution): nickel sulfamate (nickel is contained in the plating bath at a concentration described in Table 2)
Borate: as described in Table 2
pH: as described in Table 2

### (Electrolysis Conditions)

Temperature: 60° C.
Current density: 10 A/dm²
Anode: nickel pellet positive electrode
Time: adjusted in accordance with type of metal and quantity per unit area.

### <Heat Treatment Step>

Each of the meshes according to samples 1 to 20 among the meshes according to samples 1 to 21 was subjected to heat treatment under conditions of temperature and time as described in Table 2, thereby obtaining each of the meshes according to samples 1 to 20 each having framework 5 with its inner portion being hollow. The heat treatment step includes: a calcination step of burning the resin in an atmospheric atmosphere; and a reducing step of reducing, in a reducing atmosphere, the metal component in the surface of the framework oxidized in the calcination step. It should be noted that when “-” is described in each of the column “Temperature [° C.]” and the column “Time [Minute]” of the column “Heat Treatment Step” in Table 2, it means that the heat treatment step was not performed.

In this way, the “mesh constituted of the framework including the plurality of supporting pillar portions and the number, described in Table 3, of node portions that connects the supporting pillar portions” according to each of samples 1 to 21 was manufactured.

### <<Preparation of Mesh According to Sample 101>>

By purchasing a nickel mesh (quantity per unit area: 370 g/m²; pitch: 0.75 mm; filament diameter: 0.15 mm; opening: 0.6 mm; weave: plain weave) provided by Taiyo Wire Cloth, a mesh according to a sample 101 was prepared. In sample 101, nickel filaments merely intersect with each other, and the nickel filaments are not connected together by metallic bond. Therefore, in sample 101, no node portion is formed and there is no supporting pillar portion that connects the node portions (see Table 3).

### <<Preparation of Mesh According to Sample 102>>

A “mesh constituted of a framework including a plurality of supporting pillar portions and the number, described in Table 3, of node portions that connect the supporting pillar portions” according to a sample 102 was prepared by the following method. First, nickel plating was performed onto the mesh of sample 101 using the following composition of the plating bath and the following electrolysis conditions so as to attain a plating quantity of 130 g/m².

### (Composition of Plating Bath)

Salt (aqueous solution): nickel sulfamate (90 g/L of nickel is contained in the plating bath)
Borate: 20 g/L
pH: 4

### (Electrolysis Conditions)

Temperature: 60° C.
Current density: 10 A/dm²
Anode: nickel pellet positive electrode
Time: adjusted in accordance with type of metal and quantity per unit area.

Next, the heat treatment was performed at 1000° C. for 30 minutes, thereby obtaining the “mesh constituted of the framework including the plurality of supporting pillar portions and the number, described in Table 3, of node portions that connect the supporting pillar portions” according to sample 102.

### <<Preparation of Mesh According to Sample 103>>

A mesh according to a sample 103 was prepared by the following method. First, a conductive paste was prepared by using artificial graphite (conductive carbon particles) and an acrylic-based adhesive agent as a raw material containing carbon atoms and by dispersing 10 parts by mass of the artificial graphite (conductive carbon particles) with respect to 100 parts by mass of water (solvent). Next, the conductive paste was applied onto a surface of a polypropylene monofilament having a filament diameter of 180 μm. Next, the conductive paste was dried in vacuum at 80° C. for 0.1 hour. The water (solvent) was volatilized from the conductive paste, thereby obtaining a monofilament having conductivity. Next, nickel plating was performed on the monofilament having conductivity by using the following composition of the plating bath and the following electrolysis conditions so as to attain an average plating thickness of 5 μm. It should be noted that the average plating thickness was specified in the following manner: cross sections of the monofilament having conductivity and having been subjected to the nickel plating are taken at any five locations so as to be perpendicular to the long-side direction of the monofilament, the shortest distance from the surface of the monofilament to the surface of the plating is measured in each of the cross sections, and the average value of the shortest distances at the five locations are calculated.

### (Composition of Plating Bath)

Salt (aqueous solution): nickel sulfamate (90 g/L of nickel is contained in the plating bath)
Borate: 20 g/L
pH: 4

### (Electrolysis Conditions)

Temperature: 60° C.
Current density: 10 A/dm²
Anode: nickel pellet positive electrode
Time: adjusted in accordance with type of metal and quantity per unit area.

Next, the monofilaments having been subjected to the nickel plating were knitted in plain weave, thereby obtaining a mesh intermediate having the following pitch and opening. Next, the mesh intermediate was subjected to heat treatment at 1000° C. for 30 minutes, thereby obtaining the mesh according to sample 103. In sample 103, the monofilaments each plated with nickel merely intersect with each other, and the monofilaments each plated with nickel are not connected together by metallic bond. Therefore, in sample 103, no node portion is formed and there is no supporting pillar portion that connect the node portions (see Table 3).

TABLE 1

| | | | | | | Conductive Paste | |
|---|---|---|---|---|---|---|---|
| | | | | | | | Conductive |
| | Fabric | | | | | | Carbon |
| | | | Filament | | | Solvent | Particles |
| Sample | | | Diameter | Opening | Pitch | [Parts by | [Parts by |
| No. | Type of Resin | Weave | [mm] | [mm] | [mm] | Mass] | Mass] |
| 1 | Polypropylene | Plain Weave | 0.18 | 1.00 | 1.18 | 100 | 10 |
| 2 | Polypropylene | Twill Weave | 0.18 | 1.00 | 1.18 | 100 | 10 |
| 3 | Polypropylene | Satin Weave | 0.17 | 1.00 | 1.17 | 100 | 10 |
| 4 | Polypropylene | Honeycomb Weave | 0.17 | 0.90 | 1.07 | 100 | 10 |
| 5 | Polypropylene | Plain Weave | 0.17 | 1.00 | 1.17 | 100 | 10 |
| 6 | Polypropylene | Plain Weave | 0.17 | 1.00 | 1.17 | 100 | 9 |
| 7 | Polypropylene | Plain Weave | 0.17 | 1.00 | 1.17 | 100 | 8 |
| 8 | Polypropylene | Plain Weave | 0.17 | 0.59 | 0.76 | 100 | 10 |
| 9 | Polypropylene | Plain Weave | 0.16 | 0.58 | 0.74 | 100 | 9 |
| 10 | Polypropylene | Plain Weave | 0.18 | 0.60 | 0.78 | 100 | 9 |
| 11 | Polypropylene | Plain Weave | 0.18 | 0.60 | 0.78 | 100 | 9 |
| 12 | Polypropylene | Plain Weave | 0.15 | 0.60 | 0.75 | 100 | 11 |
| 13 | Polypropylene | Plain Weave | 0.15 | 0.60 | 0.75 | 100 | 11 |
| 14 | Polypropylene | Plain Weave | 0.3 | 0.10 | 0.4 | 100 | 8 |
| 15 | Polypropylene | Plain Weave | 0.1 | 1.00 | 1.1 | 100 | 9 |
| 16 | Polypropylene | Plain Weave | 0.3 | 0.10 | 0.4 | 100 | 10 |
| 17 | Polypropylene | Plain Weave | 0.1 | 1.00 | 1.1 | 100 | 11 |
| 18 | Polypropylene | Plain Weave | 0.1 | 1.00 | 1.1 | 100 | 12 |
| 19 | Polypropylene | Plain Weave | 0.18 | 0.60 | 0.78 | 100 | 13 |
| 20 | Polypropylene | Plain Weave | 0.18 | 0.60 | 0.78 | 100 | 11 |
| 21 | Carbon Fiber (PAN) | Plain Weave | 0.07 | 0.60 | 0.67 | — | — |
| 101 | — | — | — | — | — | — | — |
| 102 | — | — | — | — | — | — | — |
| 103 | — | — | — | — | — | — | — |

TABLE 2

| | Plating Step | | | Heat Treatment Step | |
|---|---|---|---|---|---|
| Sample | Nickel | Borate | | Temperature | Time |
| No. | [g/L] | [g/L] | pH | [° C.] | [Minute] |
| 1 | 90 | 20 | 4 | 1000 | 30 |
| 2 | 90 | 20 | 4 | 1000 | 30 |
| 3 | 90 | 20 | 4 | 1000 | 30 |
| 4 | 90 | 20 | 4 | 1000 | 30 |
| 5 | 90 | 20 | 4 | 1000 | 30 |
| 6 | 85 | 20 | 4 | 1000 | 30 |
| 7 | 80 | 20 | 4 | 1000 | 30 |
| 8 | 90 | 20 | 4 | 1000 | 30 |
| 9 | 90 | 20 | 4 | 1000 | 30 |
| 10 | 95 | 20 | 4 | 1000 | 30 |
| 11 | 90 | 20 | 4 | 1000 | 30 |
| 12 | 90 | 20 | 4 | 1000 | 30 |
| 13 | 95 | 20 | 4 | 1000 | 30 |
| 14 | 95 | 20 | 4 | 1000 | 30 |
| 15 | 90 | 20 | 4 | 1000 | 30 |
| 16 | 85 | 20 | 4 | 1000 | 30 |
| 17 | 85 | 20 | 4 | 1000 | 30 |
| 18 | 95 | 20 | 4 | 1000 | 30 |
| 19 | 85 | 20 | 4 | 1000 | 30 |
| 20 | 95 | 20 | 4 | 1000 | 30 |
| 21 | 90 | 20 | 4 | — | — |
| 101 | — | — | — | — | — |
| 102 | — | — | — | — | — |
| 103 | — | — | — | — | — |

TABLE 3

| | Number of | | | | | | | |
|---|---|---|---|---|---|---|---|---|
| | Supporting | | | | | | | |
| | Pillar | Presence/Absence | Framework Main Body | | | | | Average |
| | Portions | of Framework | Ni | First Atom | | | Opening | Equivalent |
| | Connecting | Main Body + | Content | Content | First | Second | Ratio of | Circle |
| Sample | Node | Inner | Ratio | Ratio | Ratio | Ratio | Mesh | Diameter |
| No. | Portions | Portion | [mass %] | [ppm] | D2/D1 | D4/D3 | [%] | [mm] |
| 1 | 4 | Present | 100 | Less Than 20 | 0.1 | 0.5 | 72 | 0.4 |
| 2 | 4 | Present | 100 | Less Than 20 | 0.1 | 0.5 | 20 | 0.4 |
| 3 | 4 | Present | 100 | Less Than 20 | 0.1 | 0.5 | 10 | 0.4 |
| 4 | 3 | Present | 100 | Less Than 20 | 0.1 | 0.5 | 71 | 0.4 |
| 5 | 4 | Present | 100 | Less Than 20 | 0.1 | 0.5 | 73 | 0.4 |
| 6 | 4 | Present | 99.99 | 100 | 0.1 | 0.5 | 73 | 0.4 |
| 7 | 4 | Present | 99.9 | 1000 | 0.1 | 0.5 | 73 | 0.4 |
| 8 | 4 | Present | 100 | Less Than 20 | 0.01 | 0.5 | 60 | 0.4 |
| 9 | 4 | Present | 100 | Less Than 20 | 0.9 | 0.5 | 61 | 0.4 |
| 10 | 4 | Present | 100 | Less Than 20 | 1.0 | 1.0 | 59 | 0.5 |
| 11 | 4 | Present | 100 | Less Than 20 | 0.1 | 0.1 | 59 | 0.01 |
| 12 | 4 | Present | 100 | Less Than 20 | 0.9 | 1.0 | 64 | 0.45 |
| 13 | 4 | Present | 100 | Less Than 20 | 0.9 | 1.1 | 64 | 0.5 |
| 14 | 4 | Present | 100 | Less Than 20 | 0.01 | 0.1 | 6 | 0.007 |
| 15 | 4 | Present | 100 | Less Than 20 | 0.9 | 1.0 | 83 | 0.5 |
| 16 | 4 | Present | 100 | Less Than 20 | 0.02 | 0.1 | 6 | 0.01 |
| 17 | 4 | Present | 100 | Less Than 20 | 0.9 | 1.0 | 83 | 0.5 |
| 18 | 4 | Present | 100 | Less Than 20 | 0.02 | 0.1 | 83 | 0.007 |
| 19 | 4 | Present | 100 | Less Than 20 | 0.6 | 0.3 | 59 | 0.5 |
| 20 | 4 | Present | 100 | Less Than 20 | 0.9 | 1.0 | 59 | 0.6 |
| 21 | 4 | Present | 100 | Less Than 20 | 0.3 | 0.3 | 80 | 0.5 |
| 101 | — | Absent | 100 | Less Than 20 | — | — | 70 | — |
| 102 | 4 | Absent | 100 | Less Than 20 | — | — | 68 | 0.4 |
| 103 | — | Present | 100 | Less Than 20 | — | — | 70 | — |

### <<Evaluation on Properties of Mesh>>

### <Structure of Framework>

Presence or absence of the “framework consisting of the framework main body and the inner portion surrounded by the framework main body” was specified by the above-described method. The obtained results are shown in the column “Presence or Absence of Framework Main Body+Inner Portion” in Table 3.

### <Composition of Framework Main Body>

The nickel content ratio in the framework main body was specified by the above-described method. The obtained results are shown in the column “Ni Content Ratio [mass %]” of the column “Framework Main Body” in Table 3. Moreover, the content ratio of the first atom in the framework main body was specified by the above-described method. The obtained results are shown in the column “First Atom Content Ratio [mass %]” of the column “Framework Main Body” in Table 3.

### <First Ratio D2/D1 and Second Ratio D4/D3>

In the cross section of the center of the node portion along the long-side direction of one supporting pillar portion of the two or more supporting pillar portions connected by each of the plurality of node portions, first ratio D2/D1 of minor axis D2 of the inner portion to major axis D1 of the inner portion was specified by the above-described method. The obtained results are shown in the column “D2/D1” in Table 3. In the cross section, perpendicular to the long-side direction of one supporting pillar portion of the two or more supporting pillar portions connected by each of the plurality of node portions, of the center of the supporting pillar portion, second ratio D4/D3 of second length D4 of the inner portion to first length D3 of the inner portion was specified by the above-described method. The obtained results are shown in the column “D4/D3” in Table 3.

### <Opening Ratio of Mesh>

The opening ratio of the mesh was specified by the above-described method. The obtained results are shown in the column “Opening Ratio of Mesh [%]” in Table 3.

### <Average Equivalent Circle Diameter of Supporting Pillar Portions in Cross Sections Perpendicular to Long-Side Directions of Supporting Pillar Portions>

The average equivalent circle diameter of the supporting pillar portions in the cross sections perpendicular to the long-side directions of the supporting pillar portions was specified by the above-described method. The obtained results are shown in the column “Average Equivalent Circle Diameter [mm]” in Table 3.

### <Mechanical Strength of Mesh>

The mechanical strength of the mesh was specified by using an “AUTOGRAPH AGX-10NVD” (trademark) provided by Shimadzu Corporation. The obtained results are shown in the column “Mechanical Strength [N/10 mm]” in Table 4. When the numerical value described in the column “Mechanical Strength [N/10 mm]” in Table 4 is relatively high, it means that the mechanical strength of the mesh is excellent.

Each of the meshes according to samples 1 to 21 corresponds to an example of the present embodiment. Each of the meshes according to samples 101 to 103 corresponds to a comparative example. It was found that each of the meshes according to samples 1 to 21 has much more excellent mechanical strength than that of each of the meshes according to samples 101 to 103.

### <Electrical Resistance of Mesh>

The electrical resistance of the mesh was specified by the following method. For each sample, a mesh in the form of a square having each side with a length of 5 cm is prepared. The mesh in the form of a square has a portion located 5 mm inward in each of the longitudinal direction and the lateral direction of the mesh from a first corner of the mesh, and this portion is sandwiched by a first clip terminal. The mesh in the form of a square has a portion located 5 mm inward in each of the longitudinal direction and the lateral direction of the mesh from a second corner of the mesh located diagonal to the first corner, and this portion is sandwiched by a second clip terminal. Current was caused to flow between the first clip terminal and the second clip terminal, and the electrical resistance of the mesh was measured using “BT3562 BATTERY HiTESTER” provided by HIOKIE.E. The results thus obtained are shown in the column “Electrical Resistance [mΩ]” in Table 4. When the numerical value described in the column “Electrical Resistance [mΩ]” in Table 4 is relatively low, it means that the electrical resistance of the mesh is relatively low. It was found that each of the meshes according to samples 1 to 21 has a much lower electrical resistance than that of each of the meshes according to samples 101 and 103.

### <Quantity of Framework Per Unit Area>

The quantity of the framework per unit area was specified by the above-described method. The obtained results are shown in the column “Quantity Per Unit Area [g/m²]” in Table 4. When the quantity of the framework per unit area is relatively low, it means that the mesh has a relatively light weight. It was found that each of the meshes according to samples 1 to 21 has a much lighter weight than that of the mesh according to sample 102.

### <Evaluation Test for Insulating Property>

An insulating property of a membrane sandwiched between two meshes was evaluated by the following method. First, a polyethylene (PE) membrane having a thickness of 20 μm was sandwiched between two meshes, thereby obtaining a stack. The PE membrane has an insulating property. Next, while applying a pressure of 10 t/cm² to the stack, current was caused to flow between the two meshes, and the electrical resistance of the stack was measured. The insulating property of the membrane sandwiched between the two meshes was evaluated based on the following evaluation criteria. When the electrical resistance of the stack is 10 MΩ or more, an evaluation criterion A is given. When the electrical resistance of the stack is 100 kΩ or more and less than 10 MΩ, an evaluation criterion B is given. When the electrical resistance of the stack is less than 100 kΩ, an evaluation criterion C is given. The obtained results are shown in the column “Insulating Property” in Table 4. In the present disclosure, the insulating property means how unlikely it is for electric leakage to occur in the membrane. When there is a “short circuit” between the two meshes, electric leakage is likely to occur in the membrane, thus resulting in decreased insulating property of the membrane. When the evaluation criterion is A or B, it means that the membrane is not broken by the meshes even under the application of pressure on the stack and the insulating property of the membrane sandwiched between the two meshes is secured.

### Evaluation Criteria

A: occurrence of no short circuit
B: occurrence of slight short circuit
C: occurrence of short circuit

TABLE 4

| | | | Quantity | |
|---|---|---|---|---|
| | Mechanical | Electrical | Per Unit | |
| Sample | Strength | Resistance | Area | |
| No. | [N/10 mm] | [mΩ] | [g/m²] | Insulating Property |
| 1 | 60 | 6.0 | 370 | A |
| 2 | 55 | 6.1 | 370 | A |
| 3 | 50 | 6.2 | 370 | A |
| 4 | 58 | 6.1 | 370 | A |
| 5 | 63 | 5.8 | 380 | A |
| 6 | 63 | 8.0 | 370 | A |
| 7 | 65 | 10 | 370 | B |
| 8 | 60 | 6.0 | 370 | A |
| 9 | 60 | 6.0 | 370 | A |
| 10 | 55 | 6.8 | 385 | A |
| 11 | 60 | 6.0 | 373 | A |
| 12 | 60 | 6.5 | 380 | A |
| 13 | 58 | 7.0 | 365 | A |
| 14 | 65 | 5.8 | 378 | A |
| 15 | 65 | 6.0 | 373 | A |
| 16 | 80 | 5.5 | 368 | A |
| 17 | 40 | 8.0 | 370 | A |
| 18 | 60 | 6.0 | 375 | A |
| 19 | 80 | 6.0 | 365 | A |
| 20 | 55 | 7.0 | 375 | A |
| 21 | 90 | 6.1 | 350 | A |
| 101 | 20 | 20 | 370 | C |
| 102 | 30 | 6.3 | 400 | C |
| 103 | 5 | 25 | 370 | A |

It was found that the insulating property of the membrane sandwiched between the two meshes according to each of samples 1 to 21 was more excellent than the insulating property of the membrane sandwiched between the two meshes according to each of samples 101 and 102. This is due to the following reason: since unevenness in the surface of each of the meshes according to samples 1 to 21 is decreased, the membrane (for example, a membrane of a zero-gap type water electrolysis cell or the like) is prevented from being broken by the meshes even under the application of pressure on the stack of the meshes and the membrane.

In view of the above, it was found that each of the meshes according to samples 1 to 21 has excellent mechanical strength and low electrical resistance. Moreover, according to each of the meshes of samples 1 to 21, it was found that the insulating property of the insulating member (for example, the membrane) sandwiched between the two meshes can be secured.

### Second Embodiment

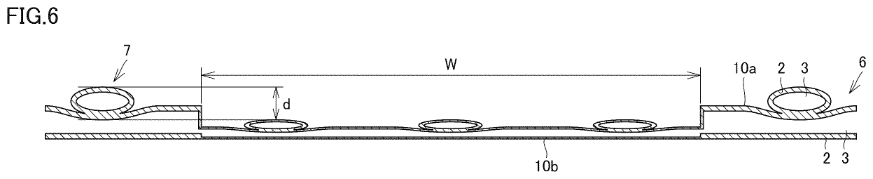

A mesh 1 according to a second embodiment will be described with reference to FIGS. 5 and 6. Mesh 1 according to the present embodiment is configured in the same manner as mesh 1 according to the first embodiment, but is different from mesh 1 according to the first embodiment in that mesh 1 according to the present embodiment is provided with a plurality of grooves 17.

Mesh 1 has a main surface 10a and a main surface 10b opposite to main surface 10a. Main surface 10a and main surface 10b are separated from each other in the thickness direction of mesh 1. In a plan view, mesh 1 has a first edge 11, a second edge 12 opposite to first edge 11, a third edge 13, and a fourth edge 14 opposite to third edge 13. Each of third edge 13 and fourth edge 14 is connected to first edge 11 and second edge 12. In the present specification, the plan view means a plan view of main surface 10a shown in FIG. 5 unless otherwise specified.

In the plan view, framework 5 has a shape of a lattice. In the present embodiment, the lattice is a quadrangular lattice, but may be a triangular lattice, a hexagonal lattice, or the like. Each of a plurality of line-shaped bodies 15 of the lattice extends from one of first edge 11, second edge 12, third edge 13, and fourth edge 14 to another one of first edge 11, second edge 12, third edge 13, and fourth edge 14. When framework 5 has a shape of a quadrangular lattice as shown in FIG. 5, the plurality of line-shaped bodies 15 are constituted of a plurality of first line-shaped bodies 15a and a plurality of second line-shaped bodies 15b, and the lattice is formed by the plurality of first line-shaped bodies 15a and the plurality of second line-shaped bodies 15b. Each of the plurality of first line-shaped bodies 15a extends from first edge 11 to second edge 12. Each of the plurality of second line-shaped bodies 15b extends from third edge 13 to fourth edge 14.

A plurality of grooves 17 are formed in main surface 10a of mesh 1. For example, each of the plurality of grooves 17 is an elongated straight groove. The plurality of grooves 17 are parallel to each other. In the plan view, the plurality of grooves 17 extend in the same direction. Each of the plurality of grooves 17 extends from first edge 11 to second edge 12. The long-side direction of each of the plurality of grooves 17 may be parallel to the long-side direction of second line-shaped body 15b. Each of the plurality of grooves 17 may extend in parallel with second line-shaped body 15b.

Each of the plurality of grooves 17 has a depth d and a width W. Depth d is provided by a difference between the height of node portion 7 in a region of mesh 1 in which the plurality of grooves 17 are not formed and the height of node portion 7 in groove 17. Depth d may be 10% or more of thickness T of mesh 1 and may be 30% or more of thickness T of mesh 1. Depth d may be 90% or less of thickness T of mesh 1. In the present embodiment, thickness T of mesh 1 is the thickness of the center of node portion 7 in which the plurality of grooves 17 are not formed. In the plan view, the area of the plurality of grooves 17 may be 10% or more of the area of main surface 10a, and may be 30% or more of the area of main surface 10a. In the plan view, the area of the plurality of grooves 17 may be 90% or less of the area of main surface 10a. In the present specification, the area of the plurality of grooves 17 means the total area of the plurality of grooves 17 in the plan view.

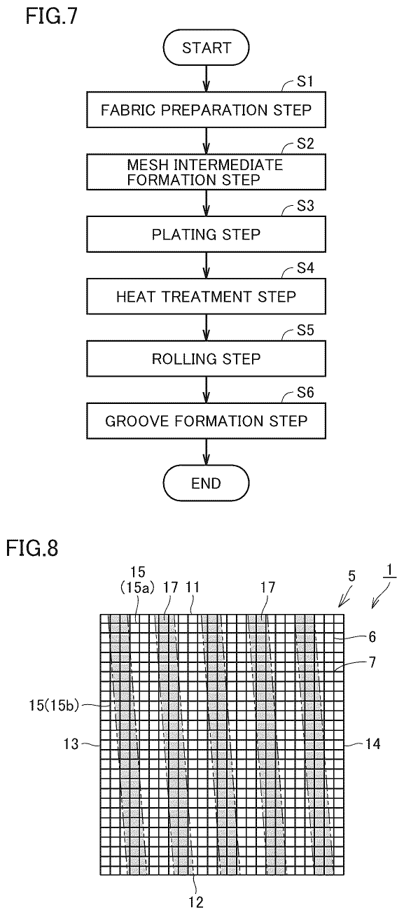

A method of manufacturing mesh 1 according to the present embodiment will be described with reference to FIG. 7. The method of manufacturing mesh 1 according to the present embodiment includes the same steps as those of the method of manufacturing mesh 1 according to the first embodiment shown in FIG. 4, but the method of manufacturing mesh 1 according to the present embodiment is different from the method of manufacturing mesh 1 according to the first embodiment in that a groove formation step (step S6) is further included.

The groove formation step (step S6) is performed after the rolling step (step S5). In the groove formation step (step S6), the plurality of grooves 17 are formed in main surface 10a. Specifically, a metal die (not shown) is pressed against main surface 10a of mesh 1. The shapes of protrusions of the metal die are transferred to main surface 10a. In this way, mesh 1 having main surface 10a in which the plurality of grooves 17 are formed is obtained.

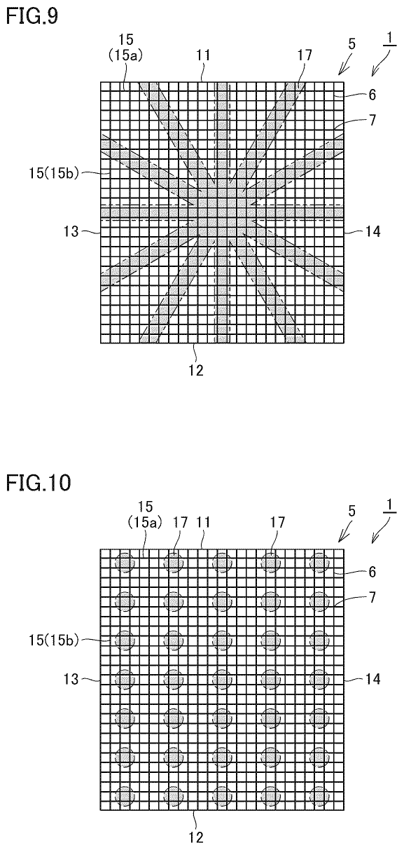

A mesh 1 according to a first modification of the present embodiment will be described with reference to FIG. 8. In mesh 1 according to the modification of the present embodiment, each of the plurality of grooves 17 is inclined with respect to the plurality of first line-shaped bodies 15a and the plurality of second line-shaped bodies 15b. In another modification of the present embodiment, the plurality of grooves 17 may be formed concentrically in the plan view. In the plan view, the plurality of grooves 17 may be formed in the form of a spiral. As shown in FIG. 9, in the plan view, the plurality of grooves 17 may be formed radially. As shown in FIG. 10, in the plan view, each of the plurality of grooves 17 may be separated from first edge 11, second edge 12, third edge 13, and fourth edge 14, and the plurality of grooves 17 may be arranged in the form of a lattice.

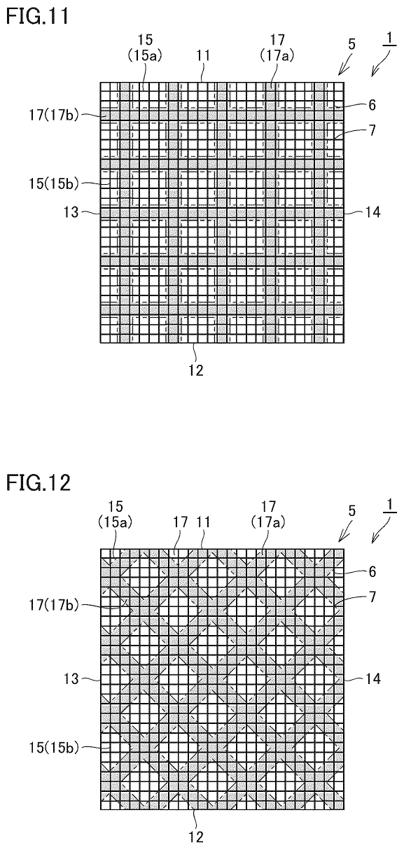

As shown in each of FIGS. 11 and 12, in the plan view, the plurality of grooves 17 may be formed by a plurality of first grooves 17a and a plurality of second grooves 17b intersecting the plurality of first grooves 17a. As shown in FIG. 11, in the plan view, each of the plurality of first grooves 17a may be parallel to the plurality of first line-shaped bodies 15a, and each of the plurality of second grooves 17b may be parallel to the plurality of second line-shaped bodies 15b. As shown in FIG. 12, in the plan view, each of the plurality of first grooves 17a may be inclined with respect to the plurality of first line-shaped bodies 15a and the plurality of second line-shaped bodies 15b, and each of the plurality of second grooves 17b may be inclined with respect to the plurality of first line-shaped bodies 15a and the plurality of second line-shaped bodies 15b.

In each of the above-described modifications of the present embodiment (for example, see the modifications shown in FIGS. 8, 10, and 12), each of the plurality of line-shaped bodies 15 has a portion (hereinafter, also referred to as a “no-groove-formed portion”) in which the plurality of grooves 17 are not formed. The minimum value of a ratio of the length of the no-groove-formed portion of each of the plurality of line-shaped bodies 15 is 10% or more. Therefore, the mechanical strength of mesh 1 is improved. The minimum value of the ratio of the length of the no-groove-formed portion of each of the plurality of line-shaped bodies 15 may be 30% or more, and may be 50% or more. In the present specification, the minimum value of the ratio of the length of the no-groove-formed portion of each of the plurality of line-shaped bodies 15 means the minimum value of the ratio of the length of the no-groove-formed portion of each of the plurality of line-shaped bodies 15 as calculated by dividing the length of the no-groove-formed portion of each of the plurality of line-shaped bodies 15 by the total length of line-shaped body 15.

### EXAMPLES

The present embodiment will be described more specifically with reference to examples. It should be noted that the present embodiment is not limited by these examples.

A mesh according to a sample 34 is the same as the mesh according to sample 1 of the first embodiment (see Tables 1 to 4), but has the number of openings and thickness T shown in Table 5. The number of openings in the mesh is the number of openings per inch (2.54 cm) in length. The plurality of grooves 17 are not provided in sample 34.

A mesh according to a sample 31 is the same as the mesh according to sample 34, but the plurality of grooves 17 as shown in FIG. 5 are formed in main surface 10a of the mesh. Depth d and the width of each of the plurality of grooves 17 and an interval between grooves 17 adjacent to each other are as shown in Table 5. Since the plurality of grooves 17 extend in parallel with second line-shaped bodies 15b in the mesh according to sample 31, the minimum value of the ratio of the no-groove-formed portion of each of the plurality of line-shaped bodies 15 is zero.

Each of meshes according to samples 32 and 33 is the same as the mesh according to sample 31, but the plurality of grooves 17 as shown in FIG. 8 are formed in main surface 10a of the mesh in each of the meshes according to samples 32 and 33. Each of the plurality of grooves 17 is inclined with respect to the plurality of first line-shaped bodies 15a and the plurality of second line-shaped bodies 15b. The minimum value of the ratio of the no-groove-formed portion of each of the plurality of line-shaped bodies 15 in the mesh according to sample 32 and the minimum value of the ratio of the no-groove-formed portion of each of the plurality of line-shaped bodies 15 in the mesh according to sample 33 are as shown in Table 5.

A solid oxide fuel cell (SOFC) in which a fuel electrode current collector was composed of the mesh according to one of samples 31 to 34 was manufactured for the sake of experiment so as to measure power generation performance and heat cycle property of the SOFC. The SOFC manufactured for the sake of experiment includes a fuel electrode interconnector, an air electrode interconnector, a solid electrolyte, an air electrode, a fuel electrode, a fuel electrode current collector, and an air electrode current collector.

Each of the fuel electrode interconnector and the air electrode interconnector is composed of an iron-chromium alloy. The solid electrolyte is disposed between the fuel electrode interconnector and the air electrode interconnector. The solid electrolyte is composed of yttria-stabilized zirconia (YSZ). The fuel electrode is disposed between the fuel electrode interconnector and the solid electrolyte. The fuel electrode is a porous body composed of a composite of nickel (Ni) and yttria-stabilized zirconia (YSZ). The air electrode is disposed between the air electrode interconnector and the solid electrolyte. The air electrode is a porous body composed of lanthanum strontium cobaltite (LSC). The fuel electrode current collector is disposed between the fuel electrode interconnector and the fuel electrode. The fuel electrode interconnector is composed of the mesh according to one of samples 31 to 34. The air electrode current collector is disposed between the air electrode interconnector and the air electrode. The air electrode current collector is composed of a silver paste.

The SOFC manufactured for the sake of experiment is heated to a temperature of 760° C. Then, hydrogen at 0.4 liters/minute and air at 0.6 liters/minute are introduced into the SOFC. Thus, the power generation performance of the SOFC was measured. Further, the heat cycle property of the SOFC was measured as follows. 20 heat cycles are applied to the SOFC while a current of 0.4 A/cm² is caused to flow through the SOFC. In each heat cycle, the temperature of the SOFC is changed between 50° C. and 760° C. Each of a temperature increase rate and a temperature decrease rate in each heat cycle is 30° C./minute. A first output voltage of the SOFC at a temperature of 760° C. in the first cycle is measured. A second output voltage of the SOFC at a temperature of 760° C. in the twentieth cycle is measured. A ratio of the second output voltage to the first output voltage is presented in percentage, thereby obtaining the heat cycle property of the SOFC.

Table 5 shows the power generation performance and heat cycle property of the SOFC manufactured for the sake of experiment. The power generation performance of the SOFC in which the fuel electrode current collector is composed of the mesh according to one of samples 31 to 33 is higher than the power generation performance of the SOFC in which the fuel electrode current collector is composed of the mesh according to sample 34. This is due to the following reason: since the plurality of grooves 17 are provided in the fuel electrode current collector, pressure loss of gas in the fuel electrode current collector is decreased to result in improved uniformity of flow of the gas in the fuel electrode current collector.

The heat cycle property of the SOFC in which the fuel electrode current collector is composed of the mesh according to one of samples 32 and 33 is more excellent than the heat cycle property of the SOFC in which the fuel electrode current collector is composed of the mesh according to sample 31. This is due to the following reason: the minimum value of the no-groove-formed portion of each of the meshes according to each of samples 32 and 33 is larger than the minimum value of the no-groove-formed portion of the mesh according to sample 31, and each of the meshes according to samples 32 and 33 has more improved mechanical strength than that of the mesh according to sample 31.

TABLE 5

| | | | | | | Minimum | | |
|---|---|---|---|---|---|---|---|---|
| | | | | | | Value of | | |
| | | | | | Interval | Length of | | |
| | Number | | Depth | | between | No- | Power | |
| | of | Thickness | of | Width of | Adjacent | Groove- | Generation | |
| Sample | Openings | of Mesh | Groove | Groove | Grooves | Formed | Performance | Heat Cycle |
| No. | of Mesh | [mm] | [mm] | [mm] | [mm] | Portion | [mW/cm²] | Property |
| 31 | 30 | 0.3 | 0.2 | 3.0 | 3.0 | 0 | 324 | 72 |
| 32 | 30 | 0.3 | 0.2 | 3.0 | 3.0 | 0.1 | 327 | 90 |
| 33 | 30 | 0.3 | 0.2 | 3.0 | 3.0 | 0.5 | 328 | 91 |
| 34 | 30 | 0.3 | — | — | — | — | 250 | — |

### Third Embodiment

Referring to FIG. 13, a water electrolysis apparatus 20 according to a third embodiment will be described. Water electrolysis apparatus 20 is, for example, a zero-gap type water alkali water electrolysis apparatus. Water electrolysis apparatus 20 includes bipolar plates 21, 22, a spacer 23, a membrane 30, a positive electrode 31, a negative electrode 32, a conductive elastic body 33, current collectors 34, 35, and conductive ribs 36, 37.

Each of bipolar plates 21, 22 is a member in the form of a flat plate. Each of bipolar plates 21, 22 is composed of, for example, an iron-chromium alloy.

Spacer 23 is disposed between bipolar plate 21 and bipolar plate 22. Spacer 23 defines an interval between bipolar plate 21 and bipolar plate 22. Spacer 23 is composed of an insulating material such as polytetrafluoroethylene (PTFE). Membrane 30, positive electrode 31, negative electrode 32, conductive elastic body 33, and current collectors 34, 35 are accommodated in an inner space defined by bipolar plates 21, 22 and spacer 23.

Membrane 30 is disposed between bipolar plate 21 and bipolar plate 22. Membrane 30 is supported by spacer 23. Membrane 30 divides the inner space defined by bipolar plates 21, 22 and spacer 23 into a positive electrode chamber 28 and a negative electrode chamber 29. Membrane 30 is an insulator and may permit ions such as hydroxide ions to pass therethrough. Membrane 30 is composed of, for example, polyphenylene sulfide (PPS).

Spacer 23 is provided with inflow ports 24, 25 and outflow ports 26, 27. Each of inflow port 24 and outflow port 26 communicates with positive electrode chamber 28. Each of inflow port 25 and outflow port 27 communicates with negative electrode chamber 29. An alkaline aqueous solution flows from inflow port 24 into positive electrode chamber 28, and flows from inflow port 25 into negative electrode chamber 29. The aqueous alkaline solution is, for example, an aqueous potassium hydroxide (KOH) solution or an aqueous sodium hydroxide (NaOH) solution. Oxygen generated in positive electrode 31 and the aqueous alkaline solution flow out from outflow port 26. The hydrogen generated in negative electrode 32 and the aqueous alkaline solution flow out from outflow port 27.

Positive electrode 31, current collector 34, and conductive rib 36 are disposed in positive electrode chamber 28. Negative electrode 32, conductive elastic body 33, current collector 35, and conductive rib 37 are disposed in negative electrode chamber 29.

Positive electrode 31 is disposed between bipolar plate 21 and membrane 30. Positive electrode 31 may be in contact with membrane 30. Negative electrode 32 is disposed between bipolar plate 22 and membrane 30. Negative electrode 32 may be in contact with membrane 30. Conductive elastic body 33 is disposed between negative electrode 32 and bipolar plate 22. Conductive elastic body 33 is in contact with negative electrode 32.

Current collector 34 is disposed between bipolar plate 21 and positive electrode 31. Current collector 34 is in contact with positive electrode 31. Current collector 34 is pressed against positive electrode 31 by conductive rib 36 protruding from bipolar plate 21. Current collector 35 is disposed between bipolar plate 22 and negative electrode 32. Current collector 35 is in contact with negative electrode 32. Current collector 35 is pressed against negative electrode 32 by conductive rib 37 protruding from bipolar plate 22.

At least one of positive electrode 31, negative electrode 32, current collector 34, or current collector 35 is composed of mesh 1 according to any one of the first embodiment, the second embodiment, and the modifications thereof.

An operation of water electrolysis apparatus 20 will be described.

The alkaline aqueous solution is supplied to positive electrode chamber 28 and negative electrode chamber 29 of water electrolysis apparatus 20 through inflow ports 24, 25. Voltage is applied between bipolar plate 21 and bipolar plate 22 so as to cause the potential of negative electrode 32 to be lower than the potential of positive electrode 31. In negative electrode 32, the water is reduced to generate hydrogen gas and hydroxide ions. The hydroxide ions are moved from negative electrode 32 to positive electrode 31 through membrane 30. In positive electrode 31, the hydroxide ions contained in the alkaline aqueous solution are oxidized to generate oxygen gas. The oxygen generated in positive electrode 31 and the aqueous alkaline solution flow out from outflow port 26. The hydrogen generated in negative electrode 32 and the aqueous alkaline solution flow out from outflow port 27.

It should be noted that water electrolysis apparatus 20 is not limited to the alkaline water electrolysis apparatus, and may be an anion exchange membrane water electrolysis apparatus or the like.

Effects of water electrolysis apparatus 20 according to the present embodiment will be described.

Water electrolysis apparatus 20 according to the present embodiment includes the current collector (current collector 34 or current collector 35), membrane 30, and the electrode (positive electrode 31 or negative electrode 32) disposed between the current collector and the membrane. At least one of the electrode or the current collector is composed of mesh 1 according to any one of the first embodiment, the second embodiment, and the modifications thereof.

Therefore, uniformity of the flow of the aqueous solution in at least one of the electrode or the current collector can be improved. Moreover, the gas generated in water electrolysis apparatus 20 is promoted to be discharged. Performance of water electrolysis apparatus 20 can be improved.

### Fourth Embodiment

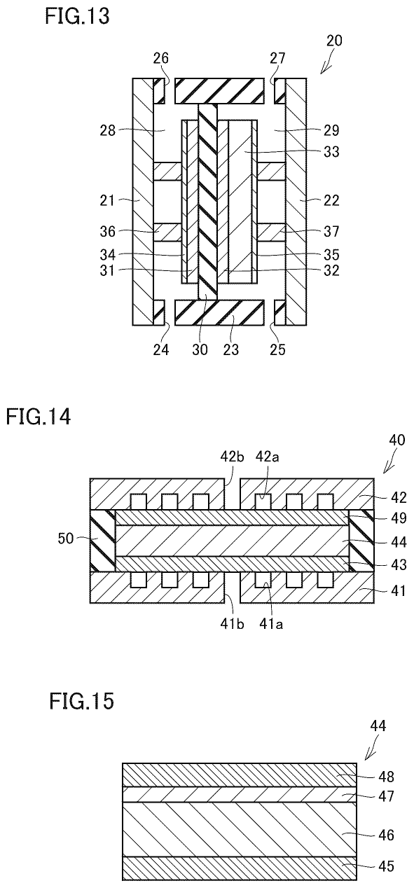

A fuel cell 40 according to a fourth embodiment will be described with reference to FIGS. 14 and 15. Fuel cell 40 according to the present embodiment is, for example, a solid oxide fuel cell (SOFC). Referring to FIG. 14, fuel cell 40 includes interconnectors 41, 42, a fuel electrode current collector 43, a cell 44, an air electrode current collector 49, and a spacer 50. Although not shown, fuel cell 40 has a cell stack structure formed by stacking unit structures including interconnectors 41, 42, fuel electrode current collector 43, cell 44, air electrode current collector 49, and spacer 50.

Each of interconnectors 41, 42 is a member in the form of a flat plate. Interconnector 41 is composed of, for example, an iron-chromium alloy. Although not shown, interconnector 42 is electrically connected to interconnector 41. Grooves 41a may be formed in a surface of interconnector 41 facing fuel electrode current collector 43. Grooves 42a may be formed in a surface of interconnector 42 facing air electrode current collector 49. Interconnector 41 is provided with an inflow port 41b and an outflow port (not shown). Interconnector 42 is provided with an inflow port 42b and an outflow port (not shown).

Spacer 50 is disposed between interconnector 41 and interconnector 42. Spacer 50 defines an interval between interconnector 41 and interconnector 42. Spacer 50 is composed of an insulating material such as mica. Fuel electrode current collector 43, cell 44, and air electrode current collector 49 are accommodated in an inner space defined by interconnectors 41, 42 and spacer 50.

Cell 44 is disposed between interconnector 41 and interconnector 42. Fuel electrode current collector 43 is disposed between interconnector 41 and cell 44. Air electrode current collector 49 is disposed between interconnector 42 and cell 44. Cell 44 is disposed between fuel electrode current collector 43 and air electrode current collector 49.

Referring to FIG. 15, cell 44 includes a fuel electrode 45, a solid electrolyte 46, and an air electrode 48. Cell 44 may further include an intermediate layer 47.

Fuel electrode 45 is a porous body in the form of a sheet. The porous body constituting fuel electrode 45 is composed of, for example, a composite of zirconia (ZrO₂) and nickel. Fuel electrode 45 may be formed by applying a conductive material to fuel electrode current collector 43.

Solid electrolyte 46 is disposed between fuel electrode 45 and air electrode 48. Solid electrolyte 46 is in contact with fuel electrode 45. Solid electrolyte 46 is a member that is in the form of a sheet and that permits oxygen ions to pass therethrough. Solid electrolyte 46 is composed of, for example, yttria-stabilized zirconia (YSZ).

Air electrode 48 is a porous body in the form of a flat plate. The porous body constituting air electrode 48 is composed of, for example, (La,Sr)MnO₃, (La,Sr)CoO₃, or the like. Air electrode 48 may be formed by applying a conductive material to air electrode current collector 49. When cell 44 does not include intermediate layer 47, air electrode 48 is in contact with solid electrolyte 46. When cell 44 includes intermediate layer 47, air electrode 48 is in contact with intermediate layer 47.

Intermediate layer 47 is disposed between solid electrolyte 46 and air electrode 48. Intermediate layer 47 prevents reaction between solid electrolyte 46 and air electrode 48. Intermediate layer 47 is composed of, for example, an oxide of Ce doped with Gd (GDC).

Fuel electrode current collector 43 is disposed between interconnector 41 and cell 44 (more specifically, fuel electrode 45). Fuel electrode current collector 43 is in contact with interconnector 41 and cell 44 (more specifically, fuel electrode 45). Air electrode current collector 49 is disposed between interconnector 42 and cell 44 (more specifically, air electrode 48). Air electrode current collector 49 is in contact with interconnector 42 and cell 44 (more specifically, air electrode 48).

In fuel cell 40 according to the present embodiment, at least one of fuel electrode current collector 43 or air electrode current collector 49 is composed of mesh 1 according to any one of the first embodiment, the second embodiment, and the modifications thereof.

An operation of fuel cell 40 will be described.

Fuel gas is supplied to fuel electrode current collector 43 and fuel electrode 45 through inflow port 41b. The fuel gas is, for example, hydrogen (H₂) gas. The fuel gas passes through grooves 41a and spreads to the whole of fuel electrode current collector 43 and the whole of fuel electrode 45.

Oxygen gas is supplied to air electrode current collector 49 and air electrode 48 through inflow port 42b. The oxygen gas passes through grooves 42a and spreads to the whole of air electrode current collector 49 and the whole of air electrode 48. Oxygen ions are moved from air electrode 48 to fuel electrode 45 through solid electrolyte 46. The oxygen ions having reached fuel electrode 45 react with the hydrogen gas supplied to fuel electrode 45 through fuel electrode current collector 43. As a result, water (H₂O) and electrons are generated. These electrons are supplied to air electrode 48 through interconnector 41, interconnector 42, and air electrode current collector 49, and ionize the oxygen gas supplied to air electrode 48 through air electrode current collector 49. The above-described reaction is repeated, with the result that fuel cell 40 generates electric power.

Effects of fuel cell 40 according to the present embodiment will be described.

Fuel cell 40 of the present embodiment includes the current collector (fuel electrode current collector 43 or air electrode current collector 49), the electrolyte (solid electrolyte 46), and the electrode (fuel electrode 45 or air electrode 48) disposed between the current collector and the electrolyte. The current collector is composed of mesh 1 according to any one of the first embodiment, the second embodiment, and the modifications thereof.

Therefore, pressure loss of the gas in the current collector is decreased to result in improved uniformity of flow of the gas in the current collector. Performance of fuel cell 40 can be improved.

The first to fourth embodiments disclosed herein are illustrative and non-restrictive in any respect. The scope of the present disclosure is defined by the terms of the claims, rather than the embodiments described above, and is intended to include any modifications within the scope and meaning equivalent to the terms of the claims.

### REFERENCE SIGNS LIST

1 mesh; 2 framework main body; 3 inner portion; 4 opening; 5 framework; 6 supporting pillar portion, 7 node portion; 10a, 10b main surface; 11 first edge; 12 second edge; 13 third edge; 14 fourth edge; 15 line-shaped body; 15a first line-shaped body; 15b second line-shaped body; 17 groove; 17a first groove; 17b second groove; 20 water electrolysis apparatus; 21, 22 bipolar plate; 23 spacer; 24, 25, 41b, 42b inflow port; 26, 27 outflow port; 28 positive electrode chamber; 29 negative electrode chamber; 30 membrane; 31 positive electrode; 32 negative electrode; 33 conductive elastic body; 34, 35 current collector; 36, 37 conductive rib; 40 fuel cell; 41, 42 interconnector; 41a, 42a groove; 43 fuel electrode current collector; 44 cell; 45 fuel electrode; 46 solid electrolyte; 47 intermediate layer; 48 air electrode; 49 air electrode current collector; 50 spacer.

1. A mesh constituted of a framework including a plurality of supporting pillar portions and a plurality of node portions, wherein
each of the plurality of node portions connects two or more supporting pillar portions of the plurality of supporting pillar portions,
the framework consists of a framework main body and an inner portion surrounded by the framework main body, and
the framework main body consists essentially of nickel or a nickel alloy.

2. The mesh according to claim 1, wherein
in a cross section of a center of each of the plurality of node portions along a long-side direction of one supporting pillar portion of the two or more supporting pillar portions, a first ratio of a minor axis of the inner portion to a major axis of the inner portion is 0.01 or more and 0.9 or less, and
in a cross section of a center of the one supporting pillar portion perpendicular to the long-side direction, a second ratio of a second length of the inner portion to a first length of the inner portion is 0.1 or more and 1.0 or less, the first length being a length of the inner portion in an in-plane direction of the mesh in the cross section of the center of the one supporting pillar portion, the second length being a length of the inner portion in a thickness direction of the mesh in the cross section of the center of the one supporting pillar portion.

3. The mesh according to claim 1, wherein
a content ratio of a first atom in the framework main body is 0 ppm or more and 100 ppm or less on a mass basis, and
the first atom is at least one atom selected from a group consisting of a phosphorus atom and a boron atom.

4. The mesh according to claim 1, wherein the inner portion is hollow.

5. The mesh according to claim 1, wherein the inner portion consists of a resin having alkali resistance or a carbon fiber having alkali resistance.

6. The mesh according to claim 5, wherein the resin having alkali resistance is at least one resin selected from a group consisting of polypropylene, polyethylene, polyester, nylon, and polytetrafluoroethylene.

7. The mesh according to claim 1, wherein an opening ratio of the mesh is 0.2% or more and 80% or less.

8. The mesh according to claim 1, wherein an average equivalent circle diameter of the plurality of supporting pillar portions in cross sections of the plurality of supporting pillar portions perpendicular to long-side directions of the plurality of supporting pillar portions is 0.007 mm or more and 0.5 mm or less.

9. The mesh according to claim 1, wherein
the mesh has a main surface in which a groove is formed,
a depth of the groove is 10% or more of a thickness of the mesh, and
in a plan view of the main surface, an area of the groove is 10% or more of an area of the main surface.

10. The mesh according to claim 9, wherein
in the plan view, the mesh has a first edge, a second edge opposite to the first edge, a third edge, and a fourth edge opposite to the third edge, and each of the third edge and the fourth edge is connected to the first edge and the second edge,
in the plan view, the framework has a shape of a lattice, and each of a plurality of line-shaped bodies of the lattice extends from one of the first edge, the second edge, the third edge, and the fourth edge to another one of the first edge, the second edge, the third edge, and the fourth edge, and
a minimum value of a ratio of a length of a portion, in which the groove is not formed, of each of the plurality of line-shaped bodies is 10% or more.

11. A water electrolysis apparatus comprising:
a current collector;
a membrane; and
an electrode disposed between the current collector and the membrane, wherein
at least one of the electrode or the current collector is composed of the mesh according to claim 1.

12. A fuel cell comprising:
a current collector;
an electrolyte; and
an electrode disposed between the current collector and the electrolyte, wherein
the current collector is composed of the mesh according to claim 1.
